(19) United States
(12) Patent Application Publication
(10) Pub. No.: US 2003/0167343 A1
(43) Pub. Date: Sep. 4, 2003

(54) Communications system

(76) Inventor: Takayuki Furuno, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/339,205

(22) Filed: Jan. 9, 2003

(30) Foreign Application Priority Data
Mar. 4, 2002 (JP) 2002-057169

(51) Int. Cl. G06F 15/173

(52) U.S. Cl. 709/244

(57) ABSTRACT

A communications system which switches from an active server to a backup server without delay or interruption, thus achieving better quality of Voice over IP (VoIP) service. The system employs a first server to centrally manage client address information and a second server to back up the first server. They serve a plurality of clients, each having a client address registration unit and a communication controller. The client address registration unit registers the client with both the first and second servers by sending client address information thereto. The communication controller receives a resolved destination IP address and an allocated network bandwidth from the first server in normal situations, and from the second server when the first server is unresponsive.

### BACKGROUND OF THE INVENTION

1. Field of the Invention

The present invention relates to a communications system, and more particularly, to a communications system which offers Voice over Internet Protocol (VoIP) services.

2. Description of the Related Art

The increasing use of the Internet in recent years has accelerated the development of network applications based on the Internet Protocol (IP), not only for data exchange, but for voice communication as well. This leads to a strong demand for integrated IP network systems that transport voice signals by using a set of techniques called Voice over IP (VoIP). People are expecting such VoIP systems to offer as high service quality and reliability (availability) as the existing telephone networks have. To meet those requirements, several kinds of basic structure and optional service of VoIP systems have been studied and formulated by some standardization organizations such as the International Telecommunication Union (ITU) and Internet Engineering Task Force (IETF). Among those are the H.323 Recommendations from ITU-T (ITU Telecommunication Standardization Sector) and Session Initiation Protocol (SIP) from IETF.

FIG. 15 shows a structure of a conventional VoIP system. This system is based on the H.323 standard suite, which employs two VoIP servers, one for active use and the other for backup. The illustrated VoIP system 100 includes the following entities on an IP network 100a (e.g., LAN in a company): a primary gatekeeper (GK) 101, an alternate gatekeeper 102, and a plurality of endpoints (EPs) 103-1 to 103-n. The endpoints 103-1 to 103-n are VOIP clients, and the primary gatekeeper 101 is a VoIP server that is currently active, while the alternate gatekeeper 102 backs up that active VoIP server.

The primary gatekeeper 101 manages the transport address of every endpoint 103-1 to 103-n in the VoIP system 100. Consider, for example, that a user “A” sitting at one endpoint 103-1 wishes to call a user “B” at another endpoint 103-2. To originate a call, the calling endpoint 103-1 sends the phone number of the destination endpoint 103-2 to the primary gatekeeper 101. As mentioned above, the phone numbers and their associated IP addresses are centrally managed in the primary gatekeeper 101. Upon receipt of a request from the requesting endpoint 103-1, the primary gatekeeper 101 executes an address translation process to identify which IP address the destination endpoint 103-2 has. The result is then sent back to the requesting endpoint 103-1.

With the destination IP address resolved, the calling endpoint 103-1 sets up a direct connection with the destination endpoint 103-2 to execute realtime voice communication. (Note that the VoIP server does not intervene between them at this stage of communication.) As such, the address translation service for zone endpoints is one of the major functions of H.323 gatekeepers. For improved availability, the alternate gatekeeper 102 is employed as a backup server, which would take over the gatekeeper tasks in case the primary gatekeeper 101 fails.

The endpoints 103-1 to 103-n in the above-described VoIP system 100 are supposed to register themselves with the primary gatekeeper 101 upon startup. The procedure of endpoint registration is stipulated as “Registration Admission and Status (RAS)” messages in the H.225.0 call signaling protocols. According to the standard, the primary gatekeeper 101 notifies the endpoints 103-1 to 103-n of the presence of an alternate gatekeeper 102 in response to a registration request (RRQ) message from them. More specifically, the primary gatekeeper 101 includes a prioritized list of alternate gatekeepers in the “AlternateGK” field of a registration confirm (RCF) message that it is sending back to each requesting endpoint 103-1 to 103-n. By parsing this “AlternateGK” information, the endpoints 103-1 to 103-n can know that, in the present example, they have one alternate gatekeeper 102 as a backup of their primary gatekeeper 101. If there are two or more alternate gatekeepers, their priorities are specified in the “AlternateGK” field.

In the conventional VoIP system 100 described above, the endpoints 103-1 to 103-n do not register themselves to the alternate gatekeeper 102 until they find their primary gatekeeper 101 unresponsive. This is the way the standard protocols stipulate; namely, the alternate gatekeeper 102 is supposed to receive registration requests from the endpoints 103-1 to 103-n when their registration attempt to the primary gatekeeper 101 is rejected, or when the primary gatekeeper 101 seems to have become unable to respond to them (for whatever reasons, including hardware/software failure) in spite of successful registration.

FIG. 16 depicts a conventional way of registering endpoint addresses with the alternate gatekeeper 102. The endpoints 103-1 to 103-n in this VoIP system 100 sends their address information to the alternate gatekeeper 102 for registration when they fail to communicate with the primary gatekeeper 101. This system, however, could encounter a problem when the alternate gatekeeper 102 is in process of taking over the gatekeeping role from the primary gatekeeper 101. Suppose, for example, that one endpoint has finished registration with the alternate gatekeeper 102 while another has not. If the former endpoint initiates a call to the latter endpoint in such a situation, the alternate gatekeeper 102 will not be able to provide the calling endpoint with the destination address, and for this reason, the call attempt has to be terminated unsuccessfully.

As can be seen from the above, the current standard way of alternate gatekeeper registration may cause a VoIP system to stop its service during a particular period when the gatekeeping function is switched from the current gatekeeper to a backup gatekeeper. To solve this service quality problem, some practitioners propose a method that transfers endpoint address information from a primary gatekeeper to alternate gatekeepers. This method, however, would merely be a proprietary approach, since the present standard recommendation provides no protocols for gatekeepers to exchange endpoint address information. Without standardized protocols, multi-vendor interconnectivity in VoIP networks cannot be achieved.

Another potential problem with the above method is that alternate gatekeepers have to update their endpoint address information in a regular fashion to keep it up to date. Particularly when alternate gatekeepers use a wide area network (WAN) connection to communicate with the primary gatekeeper located far away from them, they will need additional bandwidth in order to refresh the information regularly.

### SUMMARY OF THE INVENTION

In view of the foregoing, it is an object of the present invention to provide a VoIP communications system which switches from an active server to a backup server without delay so as to achieve better quality of service.

To accomplish the above object, the present invention provides a communications system which offers VoIP services. This system comprises the following elements: (a) a first server which centrally manages client address information; (b) a second server which is designated as a backup of the first server; and (c) a client of VoIP service. The client comprises a client address registration unit which registers the client itself with both the first and second servers by sending client address information thereto, and a communication controller which receives a resolved destination IP address and an allocated network bandwidth, from the first server in normal situations, or from the second server when the first server is unresponsive.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of a communications system according to the present invention;

FIG. 2 shows the structure of a primary gatekeeper;

FIG. 3 shows the structure of an alternate gatekeeper;

FIG. 4 is a sequence diagram which shows RAS signaling according to a first embodiment of the present invention;

FIG. 5 shows a client address table which is managed by a primary gatekeeper;

FIG. 6 shows a client address table which is managed by an alternate gatekeeper;

FIG. 7 shows a client address table when the alternate gatekeeper takes over gatekeeper tasks;

FIG. 8 is a sequence diagram which shows a RAS signaling procedure according to a second embodiment of the present invention;

FIG. 9 shows a system structure according to a third embodiment of the present invention, where a plurality of alternate gatekeepers were deployed;

FIG. 10 shows how the system is backed up by multiple alternate gatekeepers;

FIG. 11 shows the structure of a communications system according to a fourth embodiment of the present invention;

FIG. 12 is a sequence diagram which shows how the client address information is delivered in the fourth embodiment;

FIG. 13 is a flowchart of a process of how endpoint addresses are registered and how they are resolved by gatekeepers;

FIG. 14 is a functional block diagram of an endpoint;

FIG. 15 shows the structure of a conventional VoIP system; and

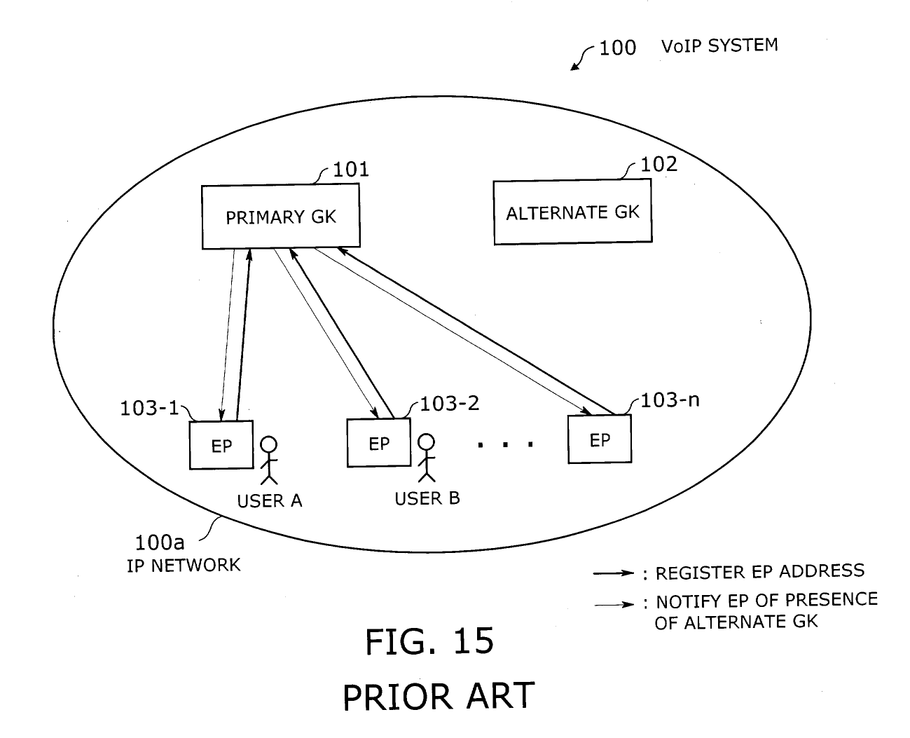

FIG. 16 shows a conventional way of registering endpoint addresses to an alternate gatekeeper.

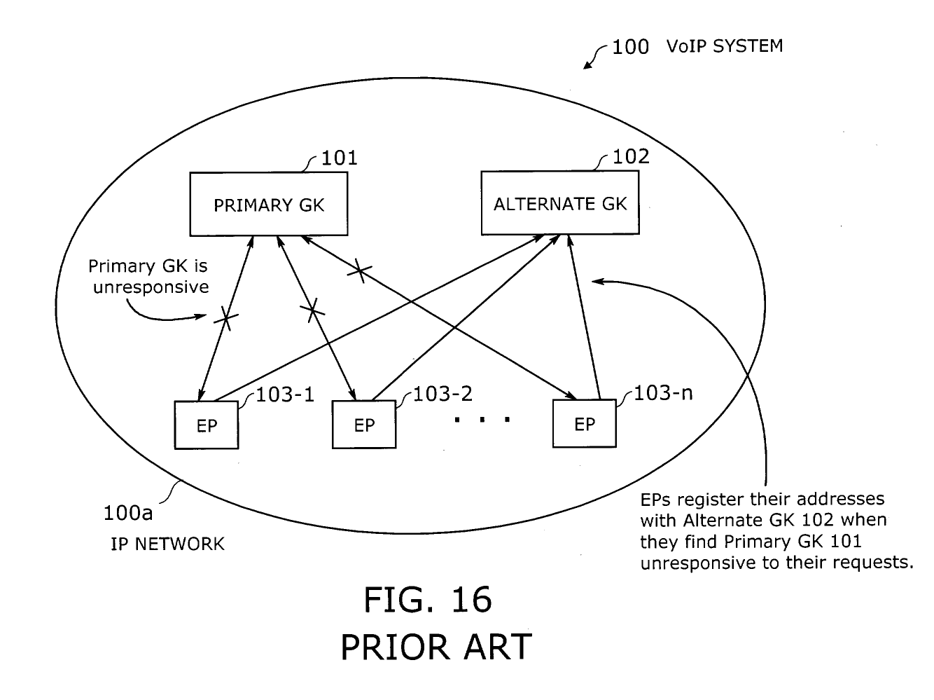

### DESCRIPTION OF THE PREFERRED EMBODIMENTS

Preferred embodiments of the present invention will be described below with reference to the accompanying drawings, wherein like reference numerals refer to like elements throughout.

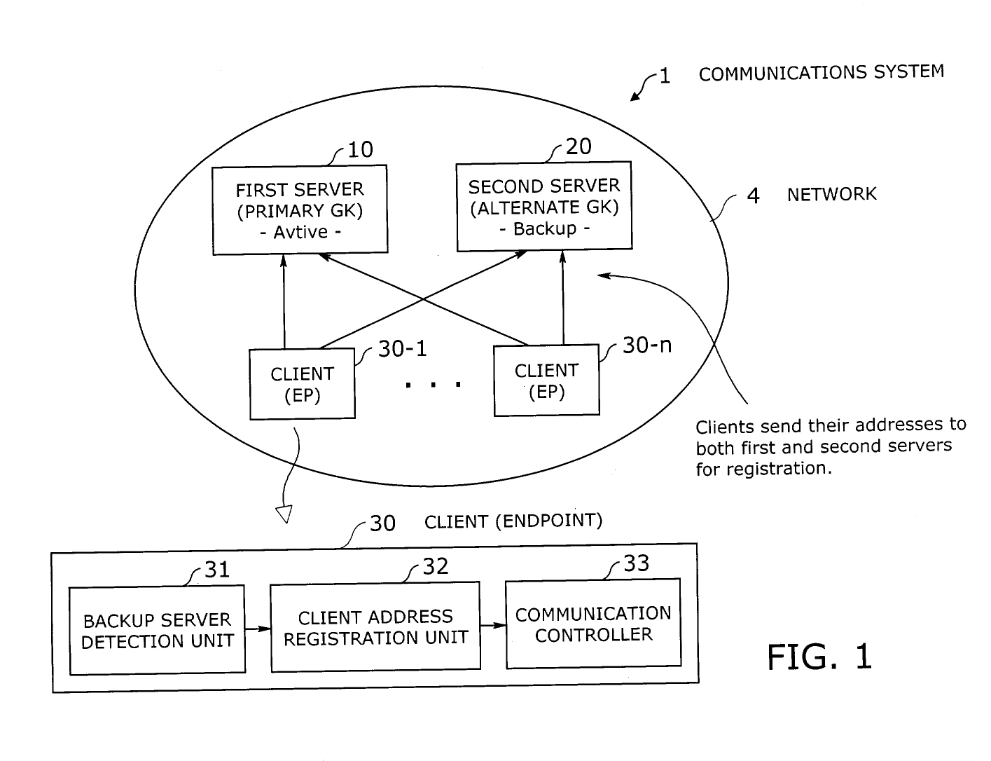

FIG. 1 is a conceptual view of a communications system 1 according the present invention. This client-server system operates in a dual redundant server configuration with two servers 10 and 20 to provide clients 30-1 to 30-n with VoIP services over a network 4 (IP network including LAN). The first server 10 shown on the left in FIG. 1 is currently working as a primary gatekeeper (GK), centrally managing client address information that is received from its clients 30-1 to 30-n. The second server 20 shown on the right in the same figure is a backup server for the first server 10, designated as an alternate gatekeeper which would take over the tasks of managing client address information in case of failure of the first server 10.

Based on their roles in the VoIP network, the above first and second servers 10 and 20 will now be referred to as the “primary gatekeeper” and “alternate gatekeeper,” respectively, and the clients 30-1 to 30-n as “endpoints” (EPs). Where appropriate, we may use the term “gatekeepers” to collectively refer to the two kinds of gatekeepers 10 and 20.

The endpoints 30-1 to 30-n (or endpoints 30, collectively) are H.323 client terminals with integral telephony functions or interface functions for external telephone sets, besides being capable of accessing the network 4. As shown in the bottom half of FIG. 1, each endpoint 30 comprises a backup server detection unit 31, a client address registration unit 32, and a communication controller 33.

The backup server detection unit 31 detects the presence of the alternate gatekeeper 20 by examining information sent from the primary gatekeeper 10 which indicates whether any alternate gatekeeper is available in the zone. At a prescribed time (e.g., upon start-up), the client address registration unit 32 sends client address information of the endpoint 30 itself for registration, not only to the primary gatekeeper 10, but also to the alternate gatekeeper 20 that is detected. The client address information includes, for example, the phone number, IP address, user name of each endpoint 30. The communication controller 33 receives a destination IP address when the endpoint 30 begins a voice communication session with a remote endpoint. While the source of this IP address information is the primary gatekeeper 10 in normal situations, it will be switched to the alternate gatekeeper 20 when the primary gatekeeper 10 becomes unresponsive. Another function of the communication controller 33 is to secure a certain amount of network bandwidth that is allocated by the primary gatekeeper 10 or alternate gatekeeper 20.

Recall that, in conventional systems, endpoints do not send their client address information to the alternate gatekeeper until they find the primary gatekeeper unresponsive. The present invention is distinct in that the endpoints 30 are designed to register their client address information not only with the primary gatekeeper 10, but also with the alternate gatekeeper 20 at the same time. This duplicate registration permits the alternate gatekeeper 20 to get ready to respond to address resolution requests from the endpoints 30 instantly when the primary gatekeeper 10 is found inoperable.

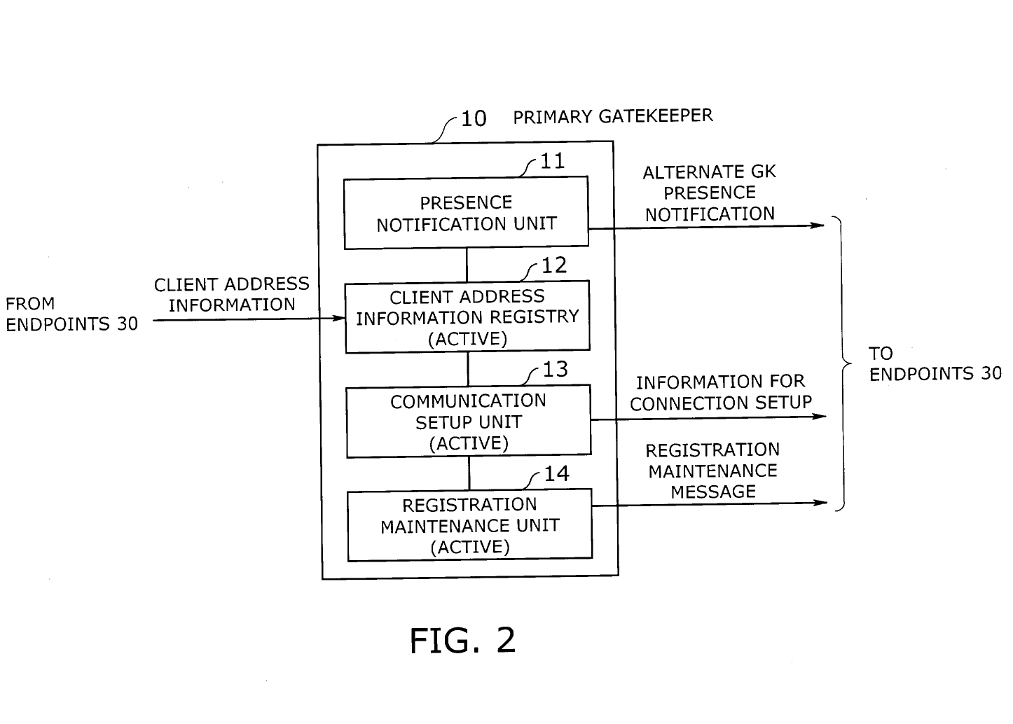

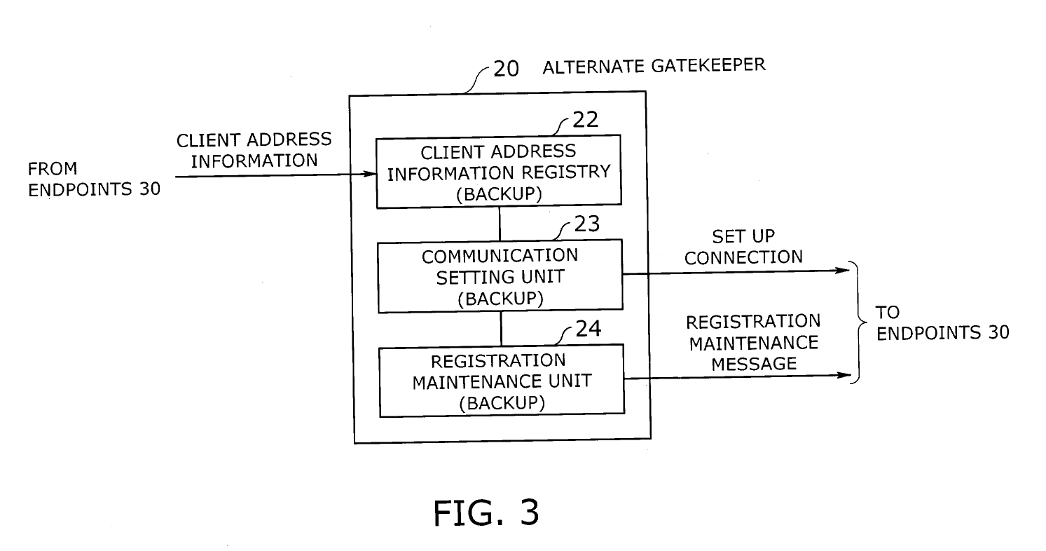

Referring next to FIGS. 2 and 3, we will describe the structure of gatekeepers in greater detail. Shown in FIG. 2 is a primary gatekeeper 10 according to the present invention, which comprises the following elements: a presence notification unit 11, a client address information registry (active) 12, a communication setup unit (active) 13, and a registration maintenance unit (active) 14. The suffix “(active)” means that those functions are activated as part of the primary gatekeeper's role.

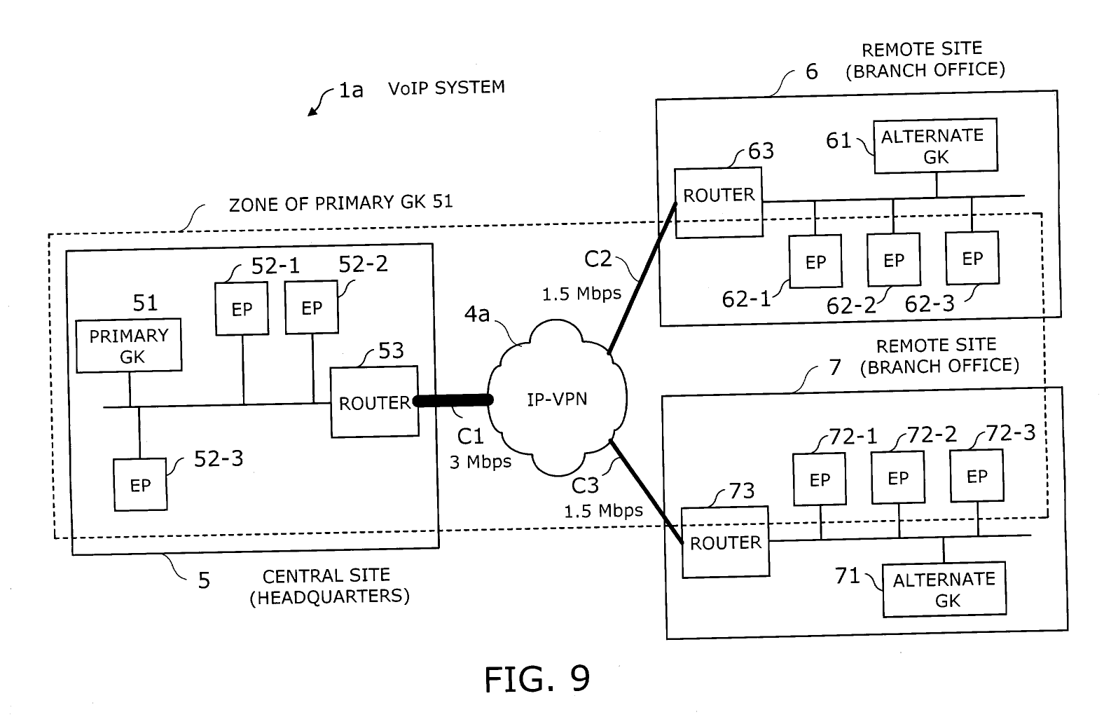

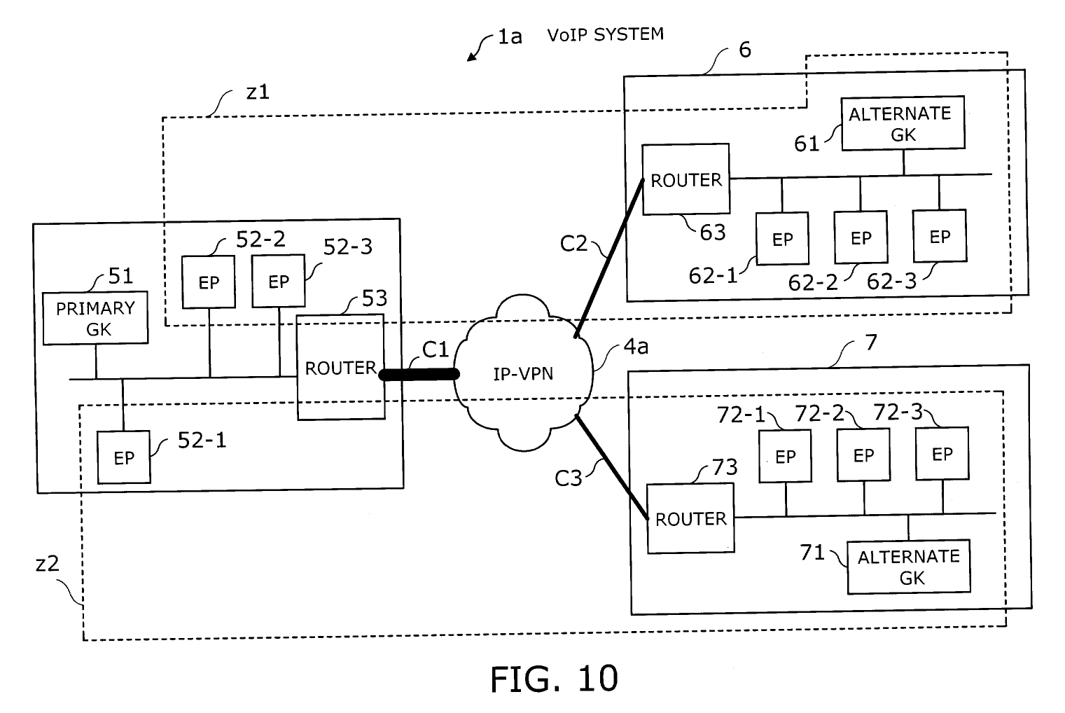

The presence notification unit 11 notifies the endpoints 30 of the presence of at least one alternate gatekeeper in the communications system 1. When two or more alternate gatekeepers are available, the presence notification unit 11 may send different information to different endpoints 30, so that their requests will be processed in a distributed way by the plural alternate gatekeepers 20. We will describe this function later in FIGS. 9 and 10.

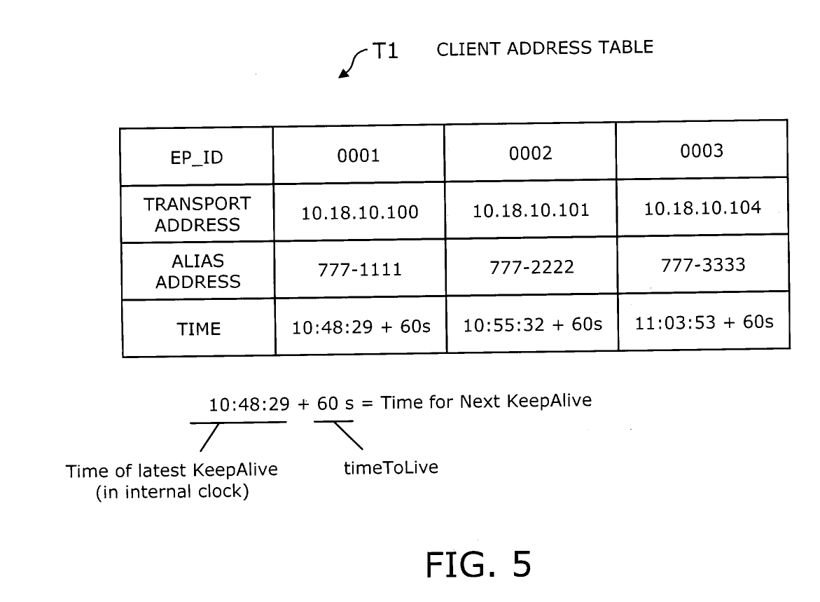

The client address information registry (active) 12 stores records of client address information received from each endpoint 30. The communication setup unit (active) 13 helps the endpoints 30 set up a connection with each other, performing address resolution on the basis of the client address information stored in the client address information registry (active) 12. More specifically, when an endpoint 30 initiates a call to a remote endpoint, the communication setup unit (active) 13 provides the calling endpoint 30 with the IP address of the destination endpoint. It also determines the amount of network bandwidth resource that can be allocated to the calling endpoint 30 to execute a call. The registration maintenance unit (active) 14 sends a registration maintenance message periodically to every registered endpoint 30 to maintain their records of client address information, as will be described later with reference to FIGS. 5 to 7.

FIG. 3 shows the structure of the alternate gatekeeper 20. The illustrated alternate gatekeeper 20 comprises the following elements: a client address information registry (backup) 22, a communication setup unit (backup) 23, and registration maintenance unit (backup) 24. The suffix “(backup)” means that those functions are part of the alternate gatekeeper's role, but it does not imply that they are inactive until the primary gatekeeper 10 becomes inoperable.

The communication setup unit (backup) 22 stores records of client address information received from the endpoints 30. The communication setup unit (backup) 23, when enabled, helps the endpoints 30 set up a connection with each other, performing address resolution on the basis of the stored client address information, providing a calling endpoint 30 with the IP address of a destination endpoint. It also determines the amount of network bandwidth resource that can be allocated to the calling endpoint 30 to execute a call. The registration maintenance unit (backup) 24 sends a registration maintenance message periodically to every registered endpoint 30 to maintain their records of client address information. During standby, it sends the message less often than the primary gatekeeper 10 does. When enabled, the message interval is shortened. We will provide more details about this function later in FIGS. 5 to 7.

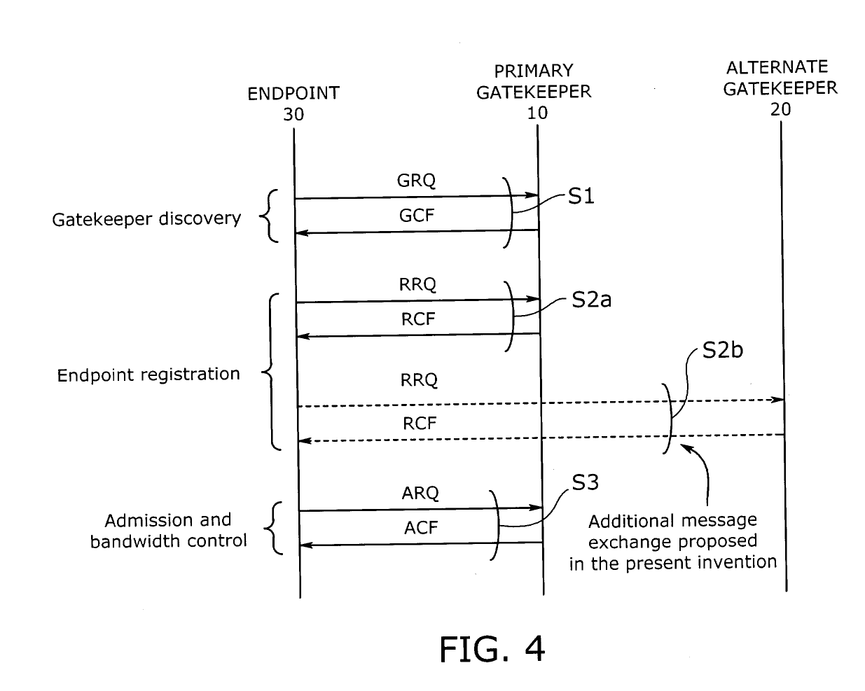

Referring now to FIG. 4, the operation of the above-described communications system 1 will be described in greater detail below. (This is referred to as a first embodiment of the present invention.)

FIG. 4 is a sequence diagram showing a RAS signaling procedure where an endpoint 30 registers its client address information with gatekeepers. RAS stands for “Registration, Admission, and Status,” the protocol to be used between endpoints and a gatekeeper to perform management functions. The sequence of FIG. 4 includes the following three stages: gatekeeper discovery, endpoint registration, and admission and bandwidth control.

The first stage “gatekeeper discovery” is an optional procedure which allows an endpoint 30 to discover its gatekeeper in a dynamic fashion. The endpoint 30 sends a multicast message to ask which server will be its gatekeeper. Gatekeepers are configured to respond to that message if the requesting endpoint is located in their own zone. The response message lets the requesting endpoint 30 know the presence of both primary and alternate gatekeepers.

The next process “endpoint registration” allows the endpoints 30 to register their client address information, including alias addresses (e.g., phone number, user name) and their corresponding IP addresses. Gatekeepers record the received client address information in their local tables, and those records are used in the subsequent “admission and bandwidth control” process. That is, when an address resolution request is received from a specific endpoint 30, the primary gatekeeper translates a given alias address key into an IP address. An appropriate amount of bandwidth is then allocated for the requested voice communication. FIG. 4 depicts the above-outlined process as follows:

(S1) The backup server detection unit 31 in an endpoint 30 transmits a Gatekeeper Request (GRQ) message, using a prescribed multicast address. This GRQ message includes an appropriate value in “supportsAltGK” field to indicate that the requesting endpoint 30 supports alternate gatekeepers. Here, the endpoint 30 does not need to notify gatekeepers of the use of the present invention, since the proposed features can be implemented on the client side alone.

The presence notification unit 11 in the primary gatekeeper 10 returns a Gatekeeper Confirm (GCF) message in response to the GRQ message from the requesting endpoint 30 in its zone. In the case that an alternate gatekeeper 20 is available in the same zone, the GCF message should include the transport address (i.e., IP address and port number) of that alternate gatekeeper 20 in its “AlternateGK” field. With this GCF message, the backup server detection unit 31 in the endpoint 30 recognizes the presence of the alternate gatekeeper 20.

Each gatekeeper is configured, manually or automatically, either as a primary gatekeeper or as an alternate gatekeeper. In automatic setup, gatekeepers may communicate with each other to exchange information and determine their roles according to the values of their IP and MAC addresses.

As mentioned earlier, the dynamic gatekeeper discovery of step S1 is an optional process. Instead, the endpoint 30 may be set up with the transport address of its gatekeeper a priority; this method is called “static discovery.”

(S2a) The client address registration unit 32 in the endpoint 30 then sends a Registration Request (RRQ) message to notify the primary gatekeeper 10 of its client address information. If the client address information registry (active) 12 is ready to accept this registration request, the primary gatekeeper 10 replies positively to the RRQ message by returning a Registration Confirm (RCF) message.

(S2b) In the same way as the endpoint registration at step S2a, the client address registration unit 32 sends an RRQ message also to the alternate gatekeeper 20 before proceeding to the phase of admission and bandwidth control. The endpoint 30 receives an RCF message as a positive response from the alternate gatekeeper 20. The above steps are executed by every endpoint that belongs to the zone of the primary gatekeeper 10.

(S3) The communication controller 33 sends an Address Request (ARQ) message to the primary gatekeeper 10, inquiring as to the IP address of a particular endpoint that the requesting endpoint 30 is attempting to call. In response to this ARQ message, the communication setup unit (active) 13 consults its local table to resolve the destination IP address from a given alias address, as well as allocating a bandwidth required for the call. The result is sent back to the requesting endpoint 30 in the form of an Address Confirm (ACF) message. Examining the ACF message arrived at the endpoint 30, the communication controller 33 obtains the destination IP address and secures the bandwidth that is allocated by the primary gatekeeper 10.

The sequence diagram of FIG. 4 only shows a normal scenario where the gatekeepers 10 and 20 always return a positive response to each GRQ, RRQ, and ARQ message from the endpoint 30. Depending on the situation, however, they may reject those requests by sending a Gatekeeper Reject (GRJ) message instead of GCF, a Registration Reject (RRJ) message instead of RCF, and an Address Reject (ARJ) message instead of ACF.

The above-described steps S1 to S3 permit the primary gatekeeper 10 and alternate gatekeeper 20 to have identical sets of client address information. When the primary gatekeeper 10 becomes unresponsive, the endpoint 30 can immediately turn to the alternate gatekeeper 20 to receive the service without any interruption. Here, the endpoint 30 may be configured to revert to the previous gatekeeper-endpoint relationship when the failed primary gatekeeper 10 has recovered. To make this reverting operation possible, the client address registration unit 32 in the endpoint 30 continues sending RRQ messages to the failed primary gatekeeper 10 to check whether it becomes operational again. The RRQ message interval, however, should be longer than usual, not to increase the network traffic and endpoint loads. When an RCF message is received in response to such RRQ, the client address registration unit 32 determines that the primary gatekeeper 10 has recovered. The endpoint 30 thus resumes communication with the primary gatekeeper 10, switching back from the alternate gatekeeper 20.

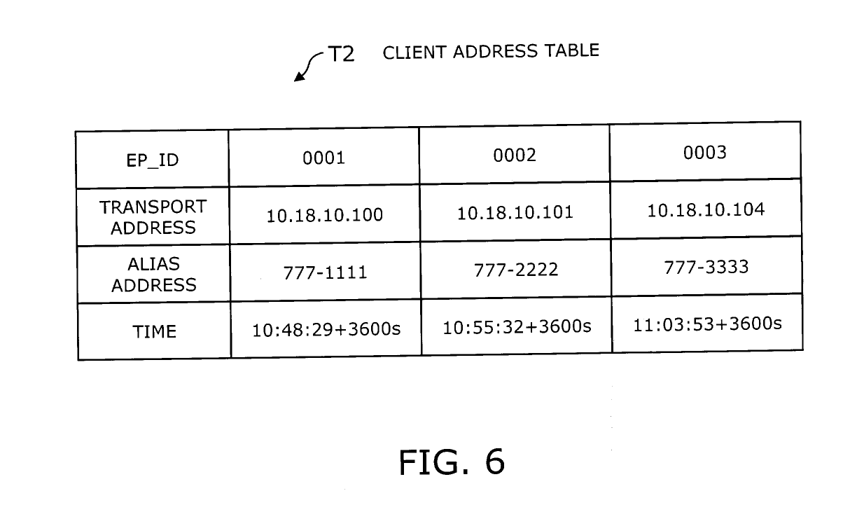

Referring next to FIGS. 5 and 6, we will provide the details of a client address table stored in gatekeepers and registration maintenance messages sent by gatekeepers. According to the present invention, both the primary and alternate gatekeepers 10 and 20 create a client address table in their local storage, based on the client address information supplied from endpoints 30 in their zone. The integrity of those endpoint registration records should be maintained by the registration maintenance unit 14 and 24 in each gatekeeper 10 and 20. That is, both the active and backup registration maintenance unit 14 and 24 periodically send a registration maintenance message to the endpoints 30 in an attempt to determine whether they are operating correctly. More specifically, this registration maintenance message is named “KeepAlive,” and the alternate gatekeeper 20 sends it to the registered endpoints 30 at longer intervals than the primary gatekeeper 10 does. Here, the KeepAlive interval is determined by a parameter called “timeToLive” expressed in seconds.

FIG. 5 shows a client address table that the primary gatekeeper 10 manages. This client address table T1 has the following fields for each entry, as shown in the left-most column: “EP_ID,” “TRANSPORT ADDRESS,” “ALIAS ADDRESS,” and “TIME.” EP_ID field and TRANSPORT ADDRESS field show the identifier and IP address of an endpoint 30, respectively. ALIAS ADDRESS field contains an alias address (e.g., phone number) of that endpoint 30. TIME field contains a time of day (based on the primary gatekeeper 10's internal clock) that shows when to transmit the next KeepAlive message. The time is expressed in the form of (HH:MM:SS+timeToLive), where HH:MM:SS indicates the time when the latest KeepAlive message was sent. Take the first entry with EP_ID=0001, for example. Its TIME field reads “10:48:29+60s,” meaning that the primary gatekeeper 10 sent the last KeepAlive at 10:48:29, and thus the next KeepAlive transmission should occur at 10:49:29 (10:48:29+60 seconds).

FIG. 6 shows a client address table managed by the alternate gatekeeper 20. While this client address table T2 is organized in the same way as the primary gatekeeper's client address table T1 we have explained in FIG. 5, it has to be noted that the timeToLive parameter in TIME field is set to 3600 seconds, which is much longer than 60 seconds, the value in table T1. As can be seen from this example, the registration maintenance unit (backup) 24 sets a longer timeToLive value for KeepAlive transmission, compared to that of the registration maintenance unit (active) 14. By doing so, the alternate gatekeeper 20 suppresses the increase of network traffic and endpoint loads.

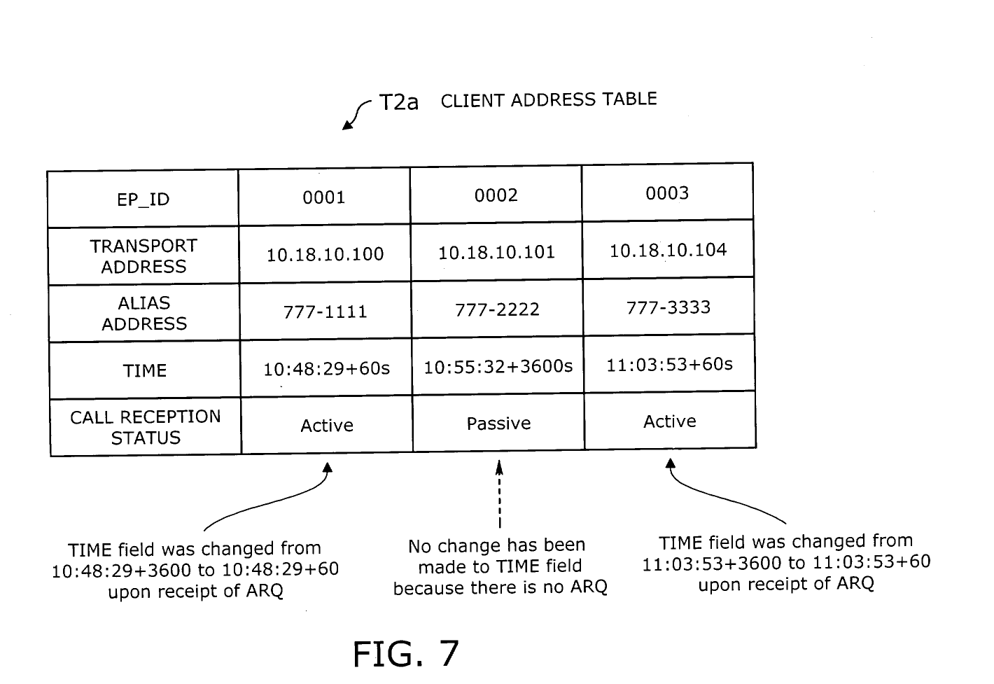

When the primary gatekeeper 10 becomes unresponsive to messages from the endpoints 30, the alternate gatekeeper 20 is enabled as a backup, which necessitates some modifications to its own client address table T2. FIG. 7 shows a client address table T2a with reduced timeToLive values, the result of modification made by the registration maintenance unit (backup) 24.

The client address table T2a has a new field entitled “CALL RECEPTION STATUS” with a value of “Active” or “Passive.” This new field is set to “Passive” until the alternate gatekeeper 20 receives an ARQ message from a corresponding endpoint for the first time after it took over the gatekeeper responsibilities from the primary gatekeeper 10. Once the CALL RECEPTION STATUS of a particular endpoint is set to “Active,” the alternate gatekeeper 20 cuts the associated timeToLive parameter since that endpoint is now under the coverage of the alternate gatekeeper 20. If CALL RECEPTION STATUS is “Passive,” it means that the endpoint has not yet recognized the alternate gatekeeper 20 as its new gatekeeper. The alternate gatekeeper 20 does not change timeToLive for such endpoints. Referring to the second entry of the client address table T2a, for example, the endpoint with EP_ID=0002 is in the Passive state and has the same TIME field value “10:55:32+3600s” as in the previous table T2 explained in FIG. 6. In contrast to this entry, the TIME field value of the endpoint with EP_ID=0001 has been changed from “10:48:29+3600s” to “10:48:29+60s.” Likewise, the endpoint with EP_ID=0003 has also a new TIME field value of “11:03:53+60s,” which is changed from “11:03:53+3600s.”

In the next section, a second embodiment of the present invention will be discussed. We have assumed in the first embodiment that the system has a single alternate gatekeeper. There can be, however, two or more alternate gatekeepers to make the system more robust. In this case, every endpoint 30 could set up a RAS channel with every alternate gatekeeper to execute the above-described RAS procedure. This situation, however, is not desirable because it could result in increased network traffic and excessive loads on the endpoints 30.

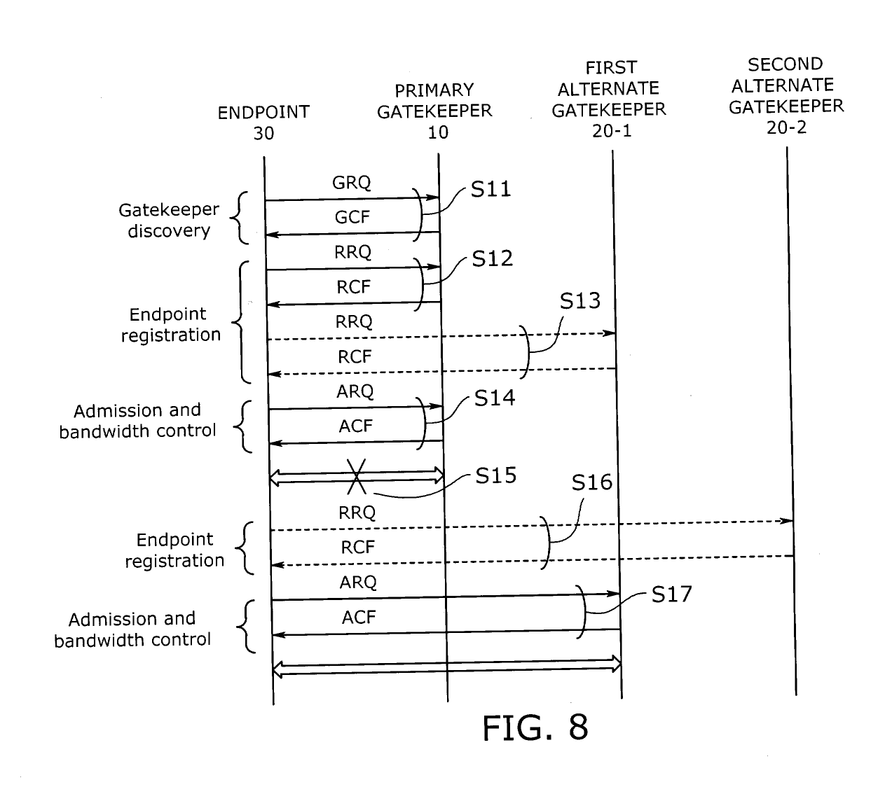

To solve the above problem, according to the second embodiment of the present invention, each endpoint 30 is configured to send its client address information, not all alternate gatekeepers, but to only one of them until it finds its primary gatekeeper 10 unresponsive, or until the activated alternate gatekeeper also becomes unresponsive. In other words, no more than one alternative gatekeeper can have client address information of a particular endpoint at any given point in time, no matter how many alternative gatekeepers are available. FIG. 8 is a sequence diagram which shows how RAS signaling messages are exchanged to accomplish the purpose, assuming that an endpoint 30 has two alternate gatekeepers 20-1 and 20-2.

(S11) The endpoint 30 discovers its primary gatekeeper 10, exchanging GRQ and GCF messages.

(S12) The endpoint 30 resisters itself with the primary gatekeeper 10, exchanging RRQ and RCF messages.

(S13) The endpoint 30 also registers itself with a first alternate gatekeeper 20-1, exchanging another set of RRQ and RCF messages.

(S14) The endpoint 30 requests admission and bandwidth control from the primary gatekeeper 10, exchanging ARQ and ACF messages.

(S15) The endpoint 30 finds the primary gatekeeper 10 unresponsive.

(S16) The endpoint 30 registers itself with a second alternate gatekeeper 20-2, exchanging RRQ and RCF messages.

(S17) The endpoint 30 requests admission and bandwidth control from the first alternate gatekeeper 20-1, exchanging ARQ and ACF messages.

As can be seen from the above sequence, the second embodiment confines endpoint registration to two gatekeepers at a time, even if there are a plurality (n) of alternate gatekeepers. First, the endpoint 30 registers with the primary gatekeeper 10 and first alternate gatekeeper endpoint 30. It is not allowed, however, for the endpoint 30 to send its client address information to the second alternate gatekeeper until the primary gatekeeper 10 fails. Likewise, it cannot make registration with the third alternate gatekeeper until the first alternate gatekeeper fails. In this way, the endpoint 30 controls itself to keep two RAS channels, but not more than that. Recall that the endpoint 30 has a prioritized list of alternate gatekeepers in “AlternateGK” field of an RCF message that it receives. The selection of two RAS channels may thus be based on the priority of each listed alternate gatekeeper.

The next section will give a third embodiment of the present invention, which allows a primary gatekeeper to send different “AlternateGK” to different endpoints in its zone when there are a plurality of alternate gatekeepers. By doing so, the system prevents the workloads from concentrating in a particular alternate gatekeeper in the case of a primary gatekeeper failure.

FIG. 9 shows a system structure according to the third embodiment of the present invention, where a plurality of alternate gatekeepers were deployed in a VoIP system 1a. The illustrated system has three local networks interconnected by a virtual private network (IP-VPN) 4a. The network in a central site (headquarters) 5 accommodates a primary gatekeeper 51, endpoints 52-1 to 52-3, and a router 53. In one remote site (branch office) 6, there are an alternate gatekeeper 61, endpoints 62-1 to 62-3, and a router 63. Another remote site (branch office) 7 has an alternate gatekeeper 71, endpoints 72-1 to 72-3, and a router 73. The router 53 is connected to the IP-VPN 4a through an access network C1 of 3 Mbps. Likewise, the router 63 is connected to the IP-VPN 4a through an access network C2 of 1.5 Mbps. The router 73 is connected to the IP-VPN 4a through an access network C3 of 1.5 Mbps.

The VoIP system 1a normally operates under the service of the primary gatekeeper 51 in the central site (headquarters) 5, which covers the entire zone indicated by the broken line in FIG. 9. If the primary gatekeeper 51 fails, its gatekeeping role is transferred to, for example, the alternate gatekeeper 61 located in the remote branch (branch office) 6. The problem here is that the new gatekeeper 61 serves endpoint terminals via a slower access network C2. This bottleneck in the access network bandwidth would result in a slow service response.

FIG. 10 shows how the system is backed up by multiple alternate gatekeepers. According to the third embodiment of the invention, the loss of the primary gatekeeper 51 is recovered by two alternate gatekeepers 61 and 71. More specifically, the first alternate gatekeeper 61 covers a zone z1, serving five endpoints 52-2, 52-3, and 62-1 to 62-3, and the second alternate gatekeeper 71 covers another zone z2, serving the remaining endpoints 52-1 and 72-1 to 72-3. To make this happen, the primary gatekeeper 51 notifies, when the system starts up, the first group of endpoints 52-2, 52-3, 62-1 to 62-3 that the first alternate gatekeeper 61 is available as their backup server. It also notifies the second group of endpoints 521 and 72-1 to 72-3 that the second alternate gatekeeper 71 will be their backup server.

Now that the two groups of endpoints know their respective alternate gatekeepers, their RAS messages will be directed to different servers if the primary gatekeeper 51 becomes unresponsive. The system can maintain its service response level since the workloads are distributed to the two gatekeepers 61 and 71.

Distributed network configurations like the VoIP system 1a of FIG. 9 are often seen in the real world, particularly in enterprise network systems. One typical concept is to deploy alternate gatekeepers at a place that is geographically separate from a primary gatekeeper, to get prepared for possible accidents or difficulties, including natural disasters. In another typical enterprise network, the primary gatekeeper is located at the company's central facilities, together with their host computer, while alternate gatekeepers are installed in remote locations, together with user terminals that are used to make access to the central host computer. The users of such distributed systems, however, are likely to experience slow system response when an alternative gatekeeper takes over the role of primary gatekeeper.

The third embodiment solves the above problem by assigning different alternative gatekeepers to different groups of endpoints. Technically, this system setup can be accomplished by varying the content of AlternateGK field, endpoint by endpoint. In other words, the zone of each alternate gatekeeper is determined according to the performance of that gatekeeper itself and the speed of an access network used to link that site to the backbone network. The single primary gatekeeper is backed up by a plurality of alternate gatekeepers in this way, its original zone being divided into smaller, more manageable segments. Accordingly, the system performance will no longer be bottlenecked on the bandwidth of access networks.

The above concept of the third embodiment could also be applied in an opposite way. That is, it is possible to back up a plurality of primary gatekeepers with a single alternative gatekeeper.

In the next section, we will present a fourth embodiment of the present invention, which employs no alternate gatekeepers, as opposed to the preceding three embodiments. Instead of using alternate gatekeepers, the fourth embodiment enables individual endpoints to translate call addresses by themselves in the case of a primary gatekeeper failure. This is made possible by the delivery of latest address information from the primary gatekeeper to individual endpoints.

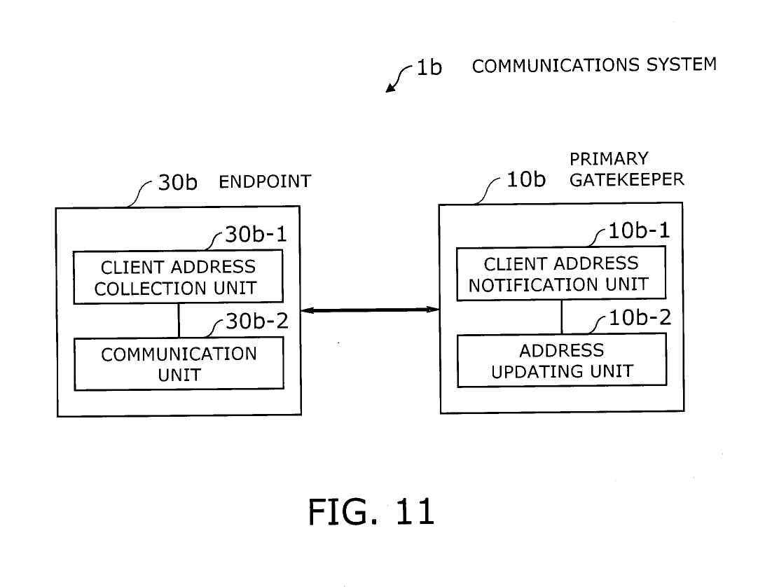

FIG. 11 shows, in a simplified manner, the structure of a communications system according to the fourth embodiment of the present invention. This communications system 1b involves a primary gatekeeper 10b and an endpoints 30b. (There may actually be more endpoints, although FIG. 11 illustrates only one example.) Each endpoint 30b has a client address collection unit 30b-1 which receives client address information and its updates from the primary gatekeeper 10, and a communication unit 30b-2 which controls client-to-client communication sessions with a peer endpoint in the case of a working server (primary gatekeeper) failure. Here, updates to the client address information include registration of new endpoints and unregistration of existing endpoints.

The primary gatekeeper 10b has a client address notification unit 10b-1 and an address updating unit 10b-2. The client address notification unit 10b-1 sends a full set of registered client address information to every endpoint that is requesting registration with the primary gatekeeper 10b. The address updating unit 10b-2 provides the registered endpoints 30b with an incremental update to their local databases when any change is made to the existing client address information in the primary gatekeeper 10.

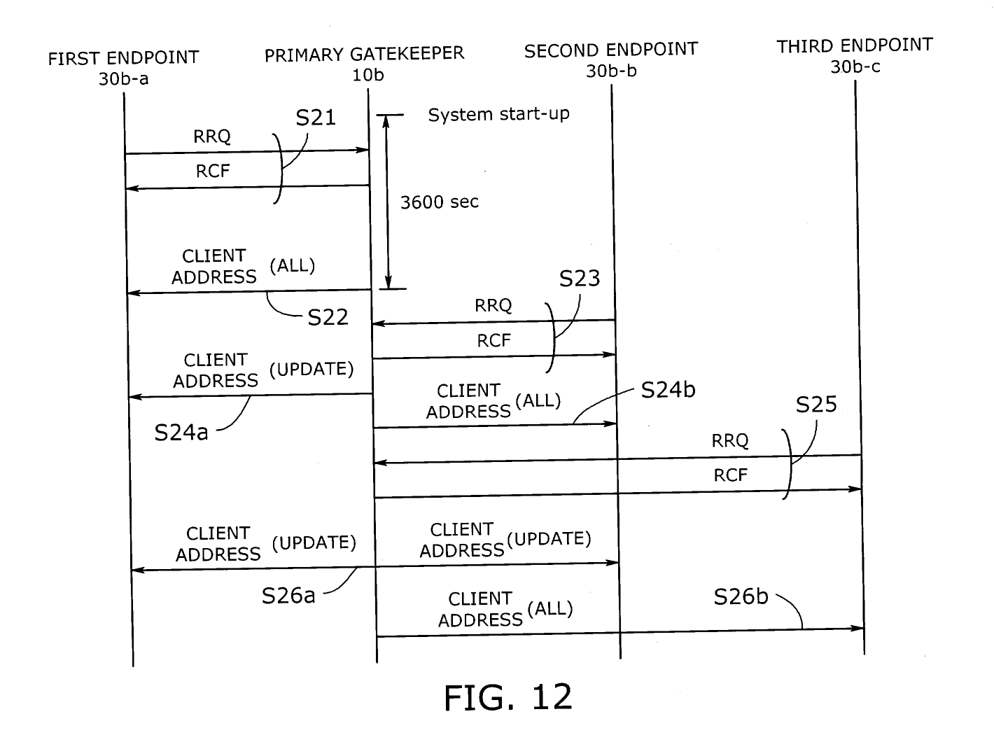

FIG. 12 is a sequence diagram which shows how the client address information is delivered in the fourth embodiment. Note that there are three endpoints 30b-a, 20b-b, and 30b-c.

(S21) The first endpoint 30b-a exchanges RRQ and RCF messages with the primary gatekeeper 10b.

(S22) Upon expiration of a predefined period (3600 seconds in the example of FIG. 12) after system startup, the primary gatekeeper 10b activates its client address notification unit 10b-1 to send all the registered client address information to the registered endpoint 30b-a. The information is received by the client address collection unit 30b-a in the endpoint 30b-a.

(S23) The second endpoint 30b-b exchanges RRQ and RCF messages with the primary gatekeeper lob. In other words, a new endpoint registration is made by the second endpoint 30b-b.

(S24a) Since a new piece of client address information is added, the primary gatekeeper 10 activates its address updating unit 10b-2, thereby sending that information to the registered endpoint 30b-a as an update to its local client address table.

(S24b) The primary gatekeeper 10b triggers its client address notification unit 10b-1 to send all the client address information to the second endpoint 30b-b that has just registered.

(S25) The third endpoint 30b-c exchanges RRQ and RCF messages with the primary gatekeeper 10b, meaning that another new endpoint registration is made by the third endpoint 30b-c.

(S26a) Since a new piece of client address information is added, the primary gatekeeper 10b activates its address updating unit 10b-2, thereby sending that information to the registered endpoints 30b-a and 30b-b as an update to their local client address tables.

(S26b) The primary gatekeeper 10b triggers its client address notification unit 10b-1 to send all the client address information to the third endpoint 30b-c that has just registered.

As can be seen from the above example, the primary gatekeeper in the fourth embodiment regularly communicate with its zone endpoints to share the latest address information stored therein. The frequency of their communication has to be limited to a minimum level, considering the workload of transmitting and receiving a large amount of client address information. For this reason, the primary gatekeeper is configured to send its current client address information to all endpoints when, for example, a predetermined time has passed after the power-up. Once this is done, the primary gatekeeper has only to supply the endpoints with subsequent update information when it becomes necessary.

The delivery of client address information may be implemented with a proprietary protocol. Or alternatively, it can be realized as an extension of RAS messages within the scope of the standard specifications. For example, the RCF message can be extended to carry client address information from a primary gatekeeper to an endpoint.

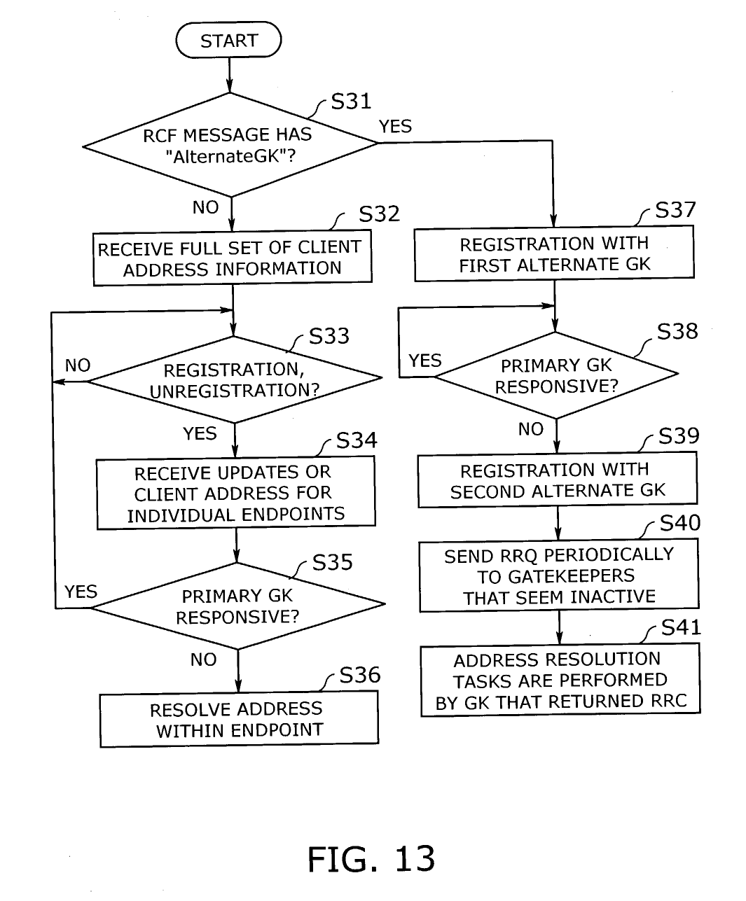

Referring now to the flowchart of FIG. 13, we will show a process of how endpoint addresses are registered and how they are resolved by a gatekeeper.

(S31) When an RCF message is received from its primary gatekeeper during an endpoint registration process, the endpoint determines whether the received RCF message has “AlternateGK” field values that indicate the presence of alternate gatekeepers. If it has, the process advances to step S37. If not, the process proceeds to step S32.

(S32) After a predefined time period, a full set of client address information arrives at the endpoint from the primary gatekeeper.

(S33) It is determined whether the system has any registration of a new endpoint or any unregistration of an existing endpoint. If it has such a change, the process advances to step S34. If not, this step S33 is repeated.

(S34) The registered endpoints receive an update to their local copy of the client address information, while a newly registered endpoint, if any, receives an entire set of client address information from its primary gatekeeper.

(S35) The process advances to step S36 if the primary gatekeeper becomes unresponsive. Otherwise, the process returns to step S33.

(S36) The endpoints resolve addresses by themselves. (S37) Now that alternate gatekeepers are discovered, the endpoints register themselves with a first alternate gatekeeper specified in “AlternateGK.”

(S38) The process advances to step S39 if the primary gatekeeper becomes unresponsive. Otherwise, this step S38 is repeated.

(S39) The endpoints register themselves with a second alternate gatekeeper.

(S40) The endpoints periodically send an RRQ message in an attempt to communicate with those gatekeepers that seem inactive.

(S41) Address resolution tasks are performed by the gatekeeper that has returned an RRC message in response to the RRQ message of step S40.

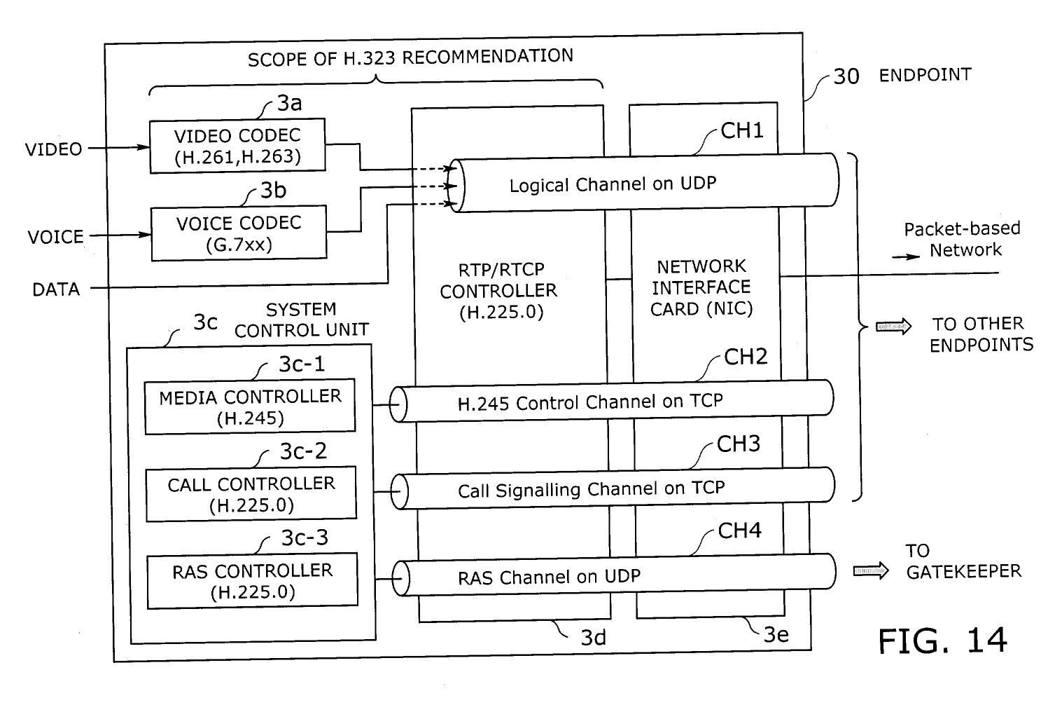

FIG. 14 is a functional block diagram of an endpoint 30. The illustrated endpoint 30 comprises the following elements: a video codec 3a, a voice codec 3b, a system control unit 3c, an RTP/RTCP controller 3d, and a network interface card (NIC) 3e.

The video codec 3a encodes and decodes video signals according to the H.261 and H.263 specifications. The voice codec 3b encodes and decodes voice signals according to the G.700 series recommendations (particularly G.710-729).

The system control unit 3c contains a media controller (H.245) 3c-1, a call controller (H.225.0) 3c-2, and a RAS controller (H.225.0) 3c-3. The media controller 3c-1 supports functions related to hierarchical relationships between endpoints and the performance of codecs being used. It also sets up a logical channel CH1 over User Datagram Protocol (UDP) transport for use in sending and receiving voice, video, and data signals. Transactions between endpoints to establish this logical channel CH1 take place on an H.245 control channel CH2 with the Transport Control Protocol (TCP).

The call controller 3c-2 interacts with a peer entity to exchange information (e.g., phone numbers) that is necessary for initiate a call between endpoints. This information is carried over a call signaling channel CH3 established between endpoints over TCP transport.

The RAS controller 3c-3 provides functions for an endpoint to register its address information (e.g., phone number) with a gatekeeper. It also performs address resolution, if required. For this purpose, the RAS controller 3c-3 sets up a RAS channel CH4 over UDP transport. The proposed endpoint functions that we have discussed in the present description are implemented as part of the RAS controller 3c-3.

The RTP/RTCP controller 3d supports RTP and RTCP protocols, where RTP stands for the Real-time Transport Protocol, and RTCP the Real-time Transport Control Protocol. To transport coded voice and video signals, the RTP/RTCP controller 3d provides such functions as IP encapsulation and IP packet monitoring. The network interface card 3e is a piece of hardware that offers data link layer and physical layer functions of LAN and other types of network connection.

As can be seen from the preceding discussion, the present invention enables endpoints to switch their registration from a primary gatekeeper to an alternate gatekeeper without interruption. With this feature of the invention, the end users can enjoy voice communication services with a high availability, without any concern about gatekeeper failure. Our explanation has assumed the use of ITU-T H.323 protocol suite because of its popularity in the IP telephony market of today. The present invention, however, should not be limited to that assumption, but can also be applied to, for example, client-server systems based on the Session Initiation Protocol, or SIP, which is expected be a new standard for VoIP products.

The above discussions are summarized as follows. According to the proposed communications system, each client registers its own client address information with both the active server and backup server, so that it will receive a destination IP address and an allocated network bandwidth from the active server in normal situations, or from the backup server when the active server is unresponsive. This feature of the present invention enables the system to switch from its active server to a backup server without delay or interruption, thus providing the users with better quality of VoIP service.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A communications system which provides VoIP services, comprising:
(a) a first server which centrally manages client address information;
(b) a second server which is designated as a backup of said first server; and
(c) a client, comprising:
a client address registration unit which registers said client itself with both said first and second servers by sending client address information thereto, and
a communication controller which receives a resolved destination IP address and an allocated network bandwidth, from said first server in normal situations, or from said second server when the first server becomes unresponsive.

2. The communications system according to claim 1, further comprising a backup server detection unit, disposed in said client, which detects the presence of said second server, based on backup server information received from said first server that indicates the presence of backup servers available in said communications system.

3. The communications system according to claim 1, further comprising a third server which is designated as another backup of said first server, wherein said client address registration unit sends the client address information of said client itself to said third server when said first server has become unresponsive.

4. The communications system according to claim 1, wherein:
said client address registration unit periodically attempts to send the client address information to said first server even after said first server has become unresponsive; and
when a registration confirm message is received from said first server in response to said attempt, said client recognizes said first server as being recovered and reverts to the original relationship with said first server.

5. The communications system according to claim 1, further comprising a third server which is designated as another backup of said first server,
wherein said first server sends different pieces of backup server information to said second and third servers, whereby said second and third servers will share workloads after said first server becomes unresponsive.

6. The communications system according to claim 1, wherein:
said first server periodically sends a registration maintenance message to said client to maintain the stored client address information; and
said second server sends a registration maintenance message to said client at longer intervals than said first server does.

7. The communications system according to claim 6, wherein said second server reduces the interval of the registration maintenance message when said second server is enabled to take over tasks from said first server.

8. A client for use in a VOIP system where a second server is deployed as a backup of a first server that is serving the client, comprising:
a client address registration unit which registers the client itself with both the first and second servers by sending client address information thereto; and
a communication controller which receives a resolved destination IP address and an allocated network bandwidth, from the first server in normal situations, or from the second server when the first server becomes unresponsive.

9. The client according to claim 8, further comprising a backup server detection unit which detects the presence of the second server, based on backup server information received from the first server that indicates the presence of backup servers available in the VoIP system.

10. The client according to claim 8, wherein:
the VOIP system has a third server which is designated as another backup of said first server; and
said client address registration unit sends the client address information of the client itself to the third server when the first server has become unresponsive.

11. The client according to claim 8, wherein:
said client address registration unit periodically attempts to send the client address information to the first server even after the first server has become unresponsive; and
when a registration confirm message is received from the first server in response to said attempt, said client address registration unit recognizes the first server as being recovered and reverts to the original relationship with the first server.

12. A server which serves clients in a VoIP system, in conjunction with a plurality of backup servers that back up the server in case of failure thereof, said server comprising:
a presence notification unit which sends backup server information to the clients to indicate the presence of the backup servers, the backup server information being different from client to client, whereby the plurality of backup servers will share workloads when the server becomes unresponsive to the clients;
a client address information registry which stores records of client address information received from the clients;
a communication setup unit which performs IP address resolution and bandwidth allocation in response to a request from each client and notifies the requesting client of a resolved IP address and an allocated bandwidth; and
a registration maintenance unit which sends a registration maintenance message periodically to each client to maintain the records of client address information.

13. A backup server which backs up an active server that is serving clients in a VoIP system, comprising:
a client address registration unit which stores records of client address information received from the clients;
a communication setup unit which performs IP address resolution and bandwidth allocation in response to a request from each client and notifies the requesting client of a resolved IP address and an allocated bandwidth; and
a registration maintenance unit which sends a registration maintenance message to each client at regular intervals to maintain the records of client address information, wherein the message interval is longer than that of the active server normally, and is reduced when the backup server is enabled to take over tasks from the server.

14. A communications system which uses VoIP techniques, comprising:
(a) a plurality of clients, each comprising:
a client address collection unit which receives and stores given client address information and updates thereto, and
a communication unit which initiates a call to a remote client by resolving a destination address, based on the stored client address information, when there is no server that provides the client with address resolution service; and
(b) a server, comprising:
a client address notification unit which sends all registered client address information to the client that is requesting registration with said server, and
an address updating unit which provides each registered client with an incremental update to the client address information stored therein when a new piece of client-address information is registered to the server.

15. A client for use in a VOIP system, comprising:
a client address collection unit which receives and stores given client address information and updates thereto; and
a communication unit which initiates a call to a remote client by resolving a destination address, based on the client address information stored in said client address collection unit, when there is no server that provides the client with address resolution service.

16. A server for use in a VOIP system, comprising:
a client address notification unit which sends all registered client address information to a client that is requesting registration with the server; and
an address updating unit which provides each registered client with an incremental update to the client address information stored therein when a new piece of client address information is registered to the server.

17. A communication method for use in a VoIP system where gatekeepers with VOIP server functions are employed to serve endpoints as clients thereof, the method comprising the steps of:
(a) performing a gatekeeper discovery process in which an endpoint identifies a first and second gatekeepers, the first gatekeeper being an active server currently serving the endpoint, the second gatekeeper being a backup of the first gatekeeper;
(b) performing an endpoint registration process in which the endpoint registers itself with both the first and second gatekeepers by sending client address information thereto;
(c) performing an admission and bandwidth control process in which the endpoint receives a resolved destination IP address and an allocated bandwidth from one of the gatekeepers with which the endpoint is registered; and
(d) changing which gatekeeper to use in the admission and bandwidth control process in said step (c), from the first gatekeeper to the second gatekeeper, when the first gatekeeper becomes unresponsive.

18. The communication method according to claim 17, further comprising the step (e) of registering the endpoint with a third gatekeeper when the first gatekeeper has become unresponsive, wherein:
the third gatekeeper is as another backup of the first gatekeeper, and
said step (a) of gatekeeper discovery allows the endpoint to identify the third gatekeeper besides the first and second gatekeepers.

19. The communication method according to claim 17, further comprising the steps of:
(e) periodically attempting to send the client address information from the endpoint to the first gatekeeper even after the first gatekeeper has become unresponsive; and
(f) if a registration confirm message is received from the first gatekeeper in response to the attempt in said step (e), recognizing the first gatekeeper as being recovered and thus reverting to the original relationship between the endpoint and first gatekeeper.

20. The communication method according to claim 17, wherein:
the VoIP system employs a third gatekeeper as another backup of the first gatekeeper; and
in said step (b) of gatekeeper discovery, the first gatekeeper assigns the second gatekeeper to a first group of endpoints and the third gatekeeper to a second group of endpoints, while the first gatekeeper serves both the first and second groups of endpoints.

21. The communication method according to claim 17, wherein:
each of the first and second gatekeepers periodically sends a KeepAlive message to the endpoint at intervals defined by a TimeToLive parameter; and
the second gatekeeper sets a larger value to the TimeToLive parameter thereof than that of the first gatekeeper.

22. The communication method according to claim 21, wherein the second gatekeeper reduces the value of the TimeToLive parameter when the second gatekeeper is enabled to take over tasks of the first gatekeeper.

23. A communication method using VOIP techniques, comprising the steps of:
(a) sending all registered client address information from a server to a client that is requesting registration with the server;
(b) sending an incremental update from the server to each client that has registered with the server, wherein the incremental update contains a new piece of client address information added to the server;
(c) updating the client address information in the client with the incremental update sent from the server; and
(d) initiating a call from the client by resolving a call destination address, based on the client address information that has been stored and updated in the client, when the server is unresponsive and unable to provide address resolution service.
